(19) United States
(12) Patent Application Publication
(10) Pub. No.: US 2020/0050414 A1
(43) Pub. Date: Feb. 13, 2020

(54) MEDIA AND DEVICE FOR ADAPTABLE DISPLAY

(71) Applicant: INTEL CORPORATION, Santa Clara, CA (US)

(72) Inventors: Zana Ilhan, Shannon (IE); Donald Korinke, Vancouver, WA (US); Eric R. Auzas, Scottsdale, AZ (US); Rajnish Maini, Chandler, AZ (US)

(73) Assignee: INTEL CORPORATION, Santa Clara, CA (US)

(21) Appl. No.: 16/343,593

(22) PCT Filed: Nov. 17, 2016
(86) PCT No.: PCT/US2016/062607

§ 371 Date: Apr. 19, 2019

(51) Int. Cl. G06F 3/14; G09G 5/14; G09G 3/20

(52) U.S. Cl. CPC G06F 3/14; G09G 5/14; G09G 2330/02; G09G 2370/16; G09G 3/2096

(57) ABSTRACT

Systems and methods for displaying enhanced video on a video panel using two connectors are provided. An example method includes plugging a media device into a display panel, determining if two connectors on the media device are coupled to the display panel. If so, the media device is configured to provide enhanced video.

### TECHNICAL FIELD

The present techniques relate generally to Internet of Things (IoT) devices. More specifically the present techniques relate to devices that can perform remote sensing and video functions.

### BACKGROUND

A current view of the Internet is the connection of clients, such as personal computers, tablets, smart phones, servers, digital photo-frames, and many other types of devices, to publicly-accessible data-centers hosted in server farms. However, this view represents a small portion of the overall usage of the globally-connected network. A very large number of connected resources currently exist, but are not publicly accessible. Examples include corporate networks, private organizational control networks, and monitoring networks spanning the globe, often using peer-to-peer relays for anonymity.

It has been estimated that the internet of things (IoT) may bring Internet connectivity to more than 15 billion devices by 2020. For organizations, IoT devices may provide opportunities for monitoring, tracking, or controlling other devices and items, including further IoT devices, other home and industrial devices, items in manufacturing and food production chains, and the like. The emergence of IoT networks has served as a catalyst for profound change in the evolution of the Internet. In the future, the Internet is likely to evolve from a primarily human-oriented utility to an infrastructure where humans may eventually be minority actors in an interconnected world of devices.

In this view, the Internet will become a communications system for devices, and networks of devices, to not only communicate with data centers, but with each other. The devices may form functional networks, or virtual devices, to perform functions, which may dissolve once the function is performed. Challenges exist in enabling reliable, secure, and identifiable devices that can form networks as needed to accomplish tasks.

One area in which IoT devices may provide advantages is in advertising. In these applications, active displays may be able to track the efficacy of advertisements and adapt the content displayed to the environment and audience.

### BRIEF DESCRIPTION OF THE DRAWINGS

FIG. 1 is a drawing of a cloud computing network, or cloud, in communication with a number of Internet of Things (IoT) devices.

FIG. 2 is a drawing of a cloud computing network, or cloud, in communication with a mesh network of IoT devices, which may be termed a fog device, operating at the edge of the cloud.

FIG. 3 is a schematic diagram of an open pluggable specification plus (OPS+) module plugged into an OPS display panel versus an OPS+ display panel.

FIG. 4 is a schematic diagram of the signals used to control an OPS display panel.

FIG. 5 is a process flow diagram of a method for displaying enhanced image data on an OPS+ display panel.

FIG. 6 is a block diagram of an example of components that may be present in an OPS+ media device.

FIG. 7 is a block diagram of a non-transitory, machine readable medium including code to direct a processor to display enhanced image data from an OPS+ media device.

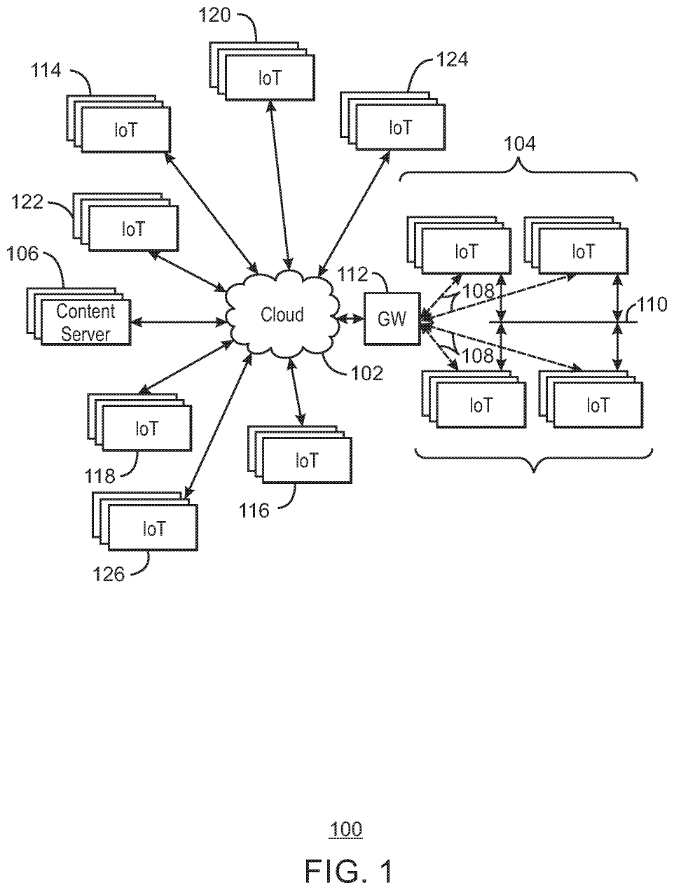

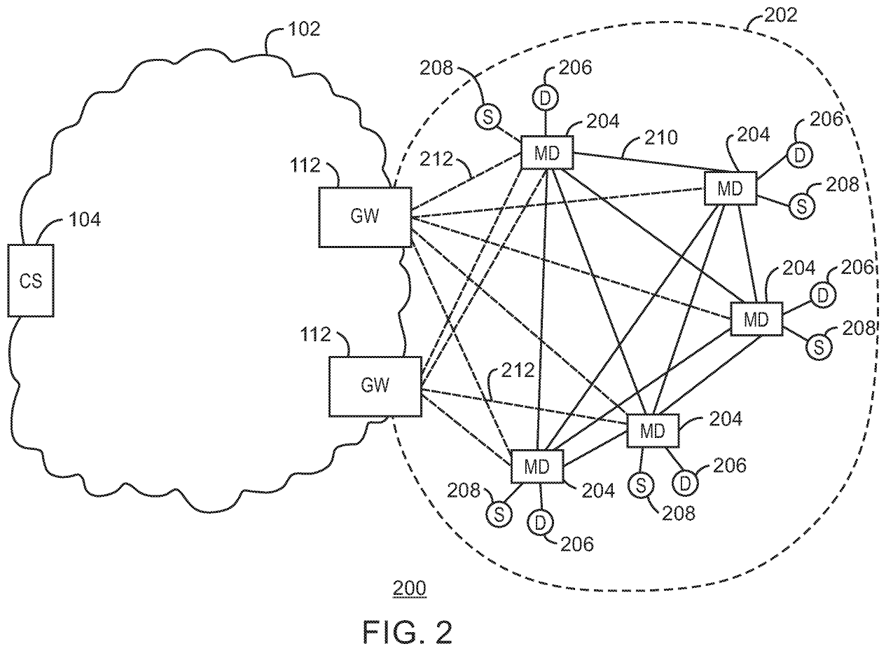

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

The internet of things (IoT) is a concept in which a large number of computing devices are interconnected to each other and to the Internet to provide functionality, such as data acquisition and actuation, at very low levels. As used herein, an IoT device may include a semiautonomous device performing a function, such as sensing or control, among others, in communication with other IoT devices and a wider network, such as the Internet. Often, IoT devices are limited in memory, size, or functionality, allowing larger numbers to be deployed for a similar cost to smaller numbers of larger devices. However, an IoT device may be a display panel and associated media device, a smart phone, a laptop, a tablet, or a personal computer, among others. Further, an IoT device may be a virtual device, such as an application on a smart phone or other computing device. IoT devices may include IoT gateways, used to couple IoT devices to other IoT devices and to cloud applications, for data storage, process control, and the like.

Networks of IoT devices may include communication devices, such as advertising displays, information kiosks, and video walls, as well as commercial and home automation devices, water distribution systems, electric power distribution systems, pipeline control systems, plant control systems, light switches, thermostats, locks, cameras, alarms, motion sensors, and the like. The IoT devices may be accessible through remote computers, servers, and other systems, for example, to control systems or access data.

FIG. 1 is a drawing of a cloud computing network, or cloud 102, in communication with a number of Internet of Things (IoT) devices. The cloud 102 may represent the Internet, or may be a local area network (LAN), or a wide area network (WAN), such as a proprietary network for a company. The IoT devices may include any number of different types of devices, grouped in various combinations. For example, a media group 104 may include media devices such as kiosks in a mall, displays in a video wall, intelligent whiteboards in a school, and the like. A content server 106 may provide media content to the media, such as advertisements, videos, teaching content, information content requested by a viewer, and the like.

The media group 104, or other subgroups, may be in communication with the cloud 102 through links 108, such as a wireless radio network, and the like. Further, a wired or wireless sub-network 110 may allow the media devices to communicate with each other, such as through a local area network, a wireless local area network, and the like. The media devices may use another device, such as a gateway 112 to communicate with the cloud 102.

Other groups of IoT devices may include remote weather stations 114, traffic control groups 116, alarm systems 118, automated teller machines 120, alarm panels 122, or moving vehicles, such as emergency vehicles 124 or other vehicles 126, among many others. Each of these IoT devices may be in communication with other IoT devices, with servers 104, or both.

As can be seen from FIG. 1, a large number of IoT devices may be communicating through the cloud 102. This may allow different IoT devices to request or provide information to other devices autonomously. For example, the media group 104 may request a current weather forecast from a group of remote weather stations 114, and may provide the forecast without human intervention, allowing it to be displayed on a sign or display panel. As another example, an emergency vehicle 124 may be alerted by an automated teller machine 120 that a burglary is in progress. As the emergency vehicle 124 proceeds towards the automated teller machine 120, it may access traffic control groups 116 to request clearance to the location, for example, by lights turning red to block cross traffic at an intersection in sufficient time for the emergency vehicle 124 to have unimpeded access to the intersection. The media group 104 may display warnings of the traffic issues on signs in the vicinity of the event.

Clusters of IoT devices, such as the remote weather stations 114 or the media group 106, may be equipped to communicate with other IoT devices as well as with the cloud 102. This may allow the IoT devices to form an ad-hoc network between the devices, allowing them to function as a single device, which may be termed a fog device. This is discussed further with respect to FIG. 2.

FIG. 2 is a drawing 200 of a cloud computing network, or cloud 102, in communication with a mesh network of IoT devices, which may be termed a fog device 202, operating at the edge of the cloud 102. Like numbered items are as described with respect to FIG. 1. In this example, the fog device 202 is a group of media devices 204, for example, in an airport, shopping mall, or process control room, or the like. The fog device 202 may be established in accordance with specifications released by the OpenFog Consortium (OFC), among others. These specifications allow the formation of a hierarchy of computing elements between the gateways 112 coupling the fog device 202 to the cloud 102 and to endpoint devices, such as displays 206 and sensors 208, in this example. It can be noted that the fog device 202 leverages the combined processing and network resources that the collective of media devices 204 provides. Accordingly, a fog device 202 may be used for any number of applications including, for example, a display wall, directed advertising, locating persons, providing information, and the like.

For example, a sensor 208 may determine that a person is looking at an advertisement on a display 206. Depending on the length of time the person is looking at the content, the associated media device 204 may identify and request related content for more advertisements. Once the person walks away from the display 206, the media device 204 may share the contact with other media devices 204 in the fog device 202, allowing them to display the related content. Similar actions may be used to allow a person to select content. For example, the sensor 208 may be used to detect that a person is looking at a particular region of a screen, such as a flight schedule or weather report. After a certain period, that region may be expanded to display over a larger region of the screen.

The fog device 202 may be a video wall, in which a series of screens or projectors, are displaying a single content or feed. In this example, the media devices 204 may share the rendering of data to have smooth transitions between displays 206.

Any number of communication links 210 may be used between the media devices 204 in the fog device 202. The communication links 210 may be radio links, for example, compatible with IEEE 802.15.4, and the like. For installations that are more fixed, such as a video wall, the links may be wire or optical links. Longer-range links 212, for example, compatible with LPWA standards, among others, may provide communications between the media devices 204 and the gateways 112. In some examples, the gateways 112 may have wire or optical links to the media devices 204, for example, providing higher bandwidth. To simplify the diagram, not every communication link 210 or 212 is labeled with a reference number.

The fog device 202 may be considered to be a massively interconnected network wherein a number of IoT devices are in communications with each other, for example, by the communication links 210 and 212. The network may be established using the open interconnect consortium (OIC) standard specification 1.0 released by the Open Connectivity Foundation™ (OCF) on Dec. 23, 2015. This standard allows devices to discover each other and establish communications for interconnects. Other interconnection protocols may also be used, including, for example, the AllJoyn protocol from the AllSeen alliance, the optimized link state routing (OLSR) Protocol, or the better approach to mobile ad-hoc networking (B.A.T.M.A.N.), among many others.

Communications from any media device 204 may be to other media devices 204 to reach the gateways 112. In these networks, the number of interconnections provide substantial redundancy, allowing communications to be maintained, even with the loss of a number of media devices 204. Further, sharing of communications may allow media devices 204 to be placed farther from the gateways 112. For example, in a shopping mall or airport, some of the media devices 204 may be placed out of communication range from the gateways 112. In this example, media devices 204 that are closer to the gateways 112 may pass on content to more distant media devices 204.

The fog device 202 may be presented to clients in the cloud 102, such as the server 104, as a single device located at the edge of the cloud 102. In this example, the control communications to specific resources in the fog device 202 may occur without identifying any specific media device 204 within the fog device 202. Accordingly, if a media device 204 fails, other media devices 204 may be able to discover and display its content.

In some examples, the media devices 204 may be configured using an imperative programming style, e.g., with each media device 204 having a specific function and communication partners. For example, a first media device 204 in the fog device 202 may be used to display flight schedules, while a second media device 204 in the fog device 202 may be used to display a newsfeed. However, the media devices 204 forming the fog device 202 may be configured in a declarative programming style, allowing the media devices 204 to reconfigure their operations and communications, such as to determine needed resources in response to conditions, queries, and device failures. As an example, in case of a fire or other emergency, the fog device 202 may reconfigure all of the media devices 204 to display emergency evacuation routes and information.

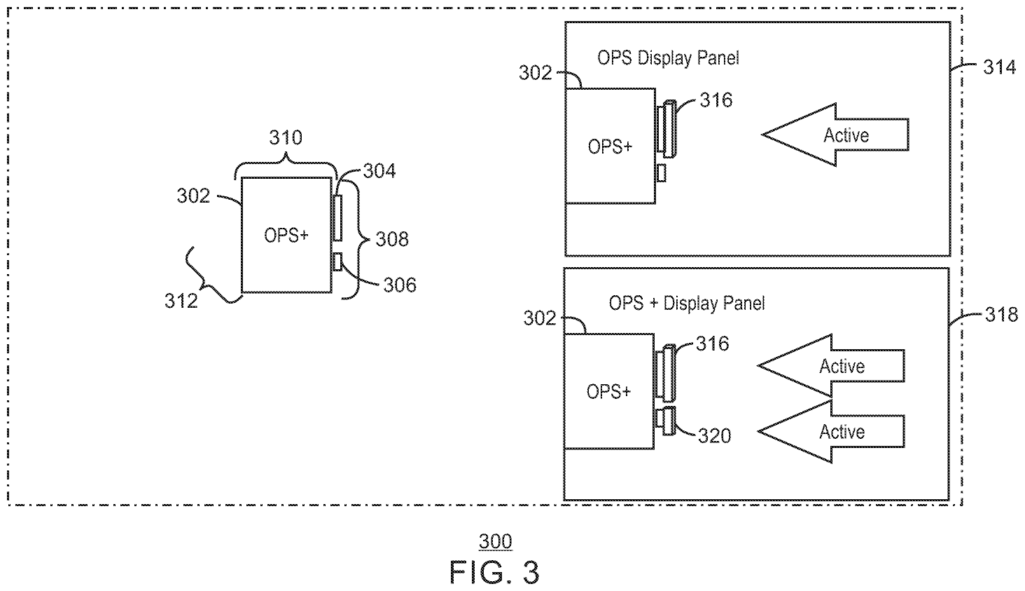

FIG. 3 is a schematic diagram 300 of an OPS+ (open pluggable specification plus) module 302 that may be used in different open pluggable specification (OPS) display panels. The OPS+ module 302 includes two active connectors for video output, a first connector 304 provides a video output that is compatible with the basic open pluggable specification (OPS). A second connector 306 provides a video output that is enhanced with respect to resolution or image speed, as described with respect to Table 1. The OPS+ module 302 may be compatible with the current OPS for video output and for size, having the same height 308, depth 310, and thickness 312, as current OPS modules.

The OPS+ module 302 may be used in an OPS display panel 314, in which the first connector 304 plugs into a matching connector 316 on the display panel 314. As the second connector 306 is not engaged with a matching connector on the OPS display panel 314, only a basic OPS video signal may be sent to the OPS display panel 314.

The OPS+ module 302 may also be used in an OPS+ display panel 318. In this example the first connector 304 plugs into a matching connector 316 on the OPS+ display panel 318. In addition, the second connector 306 plugs into a matching connector 320 on the OPS+ display panel 318. Having both connectors 304 and 306 engaged into matching connectors on the display panel enables display of high-resolution or higher-speed video, among others. For example, the second connector 306 may allow the delivery of faster frame rates, such as 8K at 60 Hz, 3 HDMI 3.0 ports providing 4K at 120 Hz, or an enhanced interface, such as PCIe x4.

TABLE 1
Changes to OPS specification provided by dual connectors

| | OPS+ | OPS |
|---|---|---|
| Connectors | JAE TX25A/TX24A (80 | JAE TX25/TX24 (80 Pins), |
| | pins) w/4K Enhanced + | w/o 4K Enhanced |
| | HRS FX18 (60 pins) | |
| Max Video | 1 × 8K @ 60 Hz, up | 4K@60 Hz |
| Supported | to 3 × 4K@ 120 Hz | |
| | (when 8K is not used) | |
| Connectivity | Up to 3 USB3.0 + 2 | Up to 1 USB3.0 + 2 |
| | USB 2.0 | USB2.0 |
| Enhanced | PCle2.0/3.0 4-lane | |
| Connectivity | Expansion | |
| Enhanced Video | Dual HDMI Screens | |

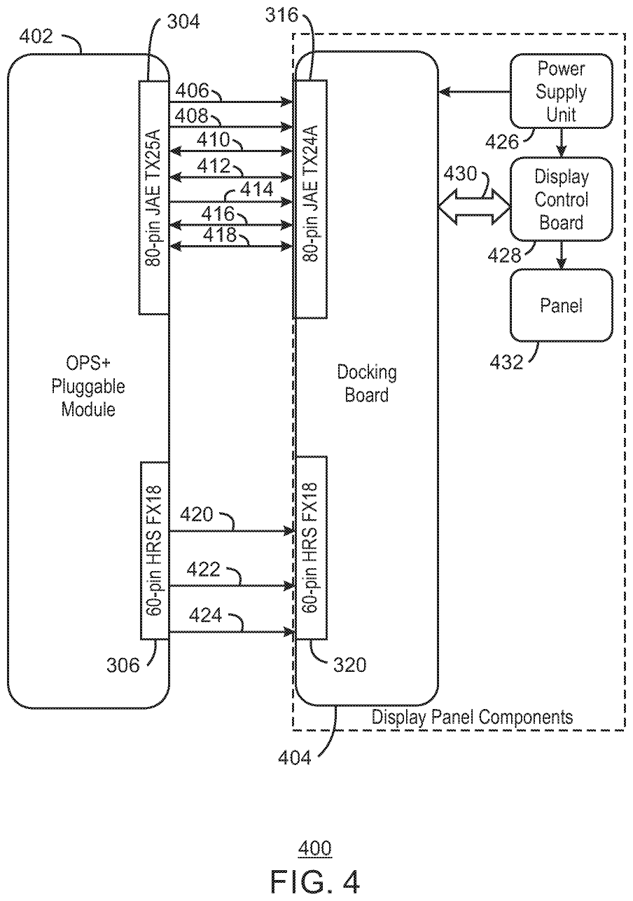

FIG. 4 is a schematic diagram 400 of an OPS+ pluggable module 402 interfaced to a docking board 404 in a display panel 406. Like numbered items are as described with respect to FIG. 3. The first connector 304 may include a number of signal lines for providing video and control from the OPS+ pluggable module 402 to the display panel 406. These may include lines 406 providing video signals, for example, in a transition-minimized differential signaling (TMDS) format, such as HDMI connections. Other video lines 408 may carry information for display port connection. Serial communications may take place between the display panel 406 and the OPS+ pluggable module 402 over UART lines 410. USB lines 412 may be used to provide a connection to USB ports on the OPS+ pluggable module 402. Audio lines 414 may carry audio signals from the OPS+ pluggable module 402 to the display panel 406. Specific control lines 416 may be used to control various functions of the display panel 406 and the OPS+ pluggable module 402, for example, allowing the pressing of the power button on the display panel 406 to trigger a shutdown of the OPS+ pluggable module 402. Power lines 418 may provide power to the OPS+pluggable module 402 from the display panel 406.

The second connector 306 may include a number of lines that enhance the video feeds, provide further interfaces, and provide additional control lines. These may include video lines 420 that may provide video signals at up to 8K at 60 Hz or multiple HDMI 2.0 signals providing 4K at 120 Hz. An interface line 422 may provide a PCIe x4 or a USB 3.0 port. Additional general purpose I/O (GPIO) lines 422 may be included for configuration by user. The GPIO may allow the control of display functions such as brightness, volume, and the like.

In addition to the docking board 404, the display panel 406 may include a number of other functional units. For example, a power supply unit 426 may be included to provide power to both the display panel 406 and, through the docking board 404, to the OPS+ pluggable module 402. A display control board 428 may accept video and control signals 430 from the OPS+ pluggable module 402 through the docking board 404. The display control board 428 may render the signals for a panel.

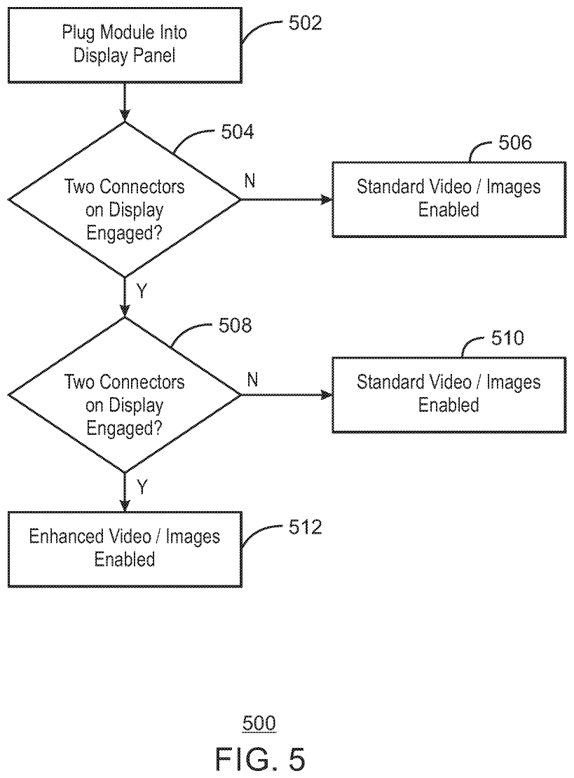

FIG. 5 is a process flow diagram of a method 500 for determining if enhanced video may be displayed. The method 500 begins at block 502, when an OPS module is plugged into display panel. At block 504, a determination is made as to whether two active connectors on the display panel are operably coupled with connectors on the OPS module. If not, at block 506, standard video and images are enabled. At block 508, a determination is made as to whether two active connectors on the OPS module are operably coupled with connectors on the display. If not at block 510, standard video and images are enabled. If two active connectors on the OPS module are engaged with active connectors on the display, then at block 512, enhanced video and images may be enabled. Further, additional connectivity may be provided by the second connector as described herein.

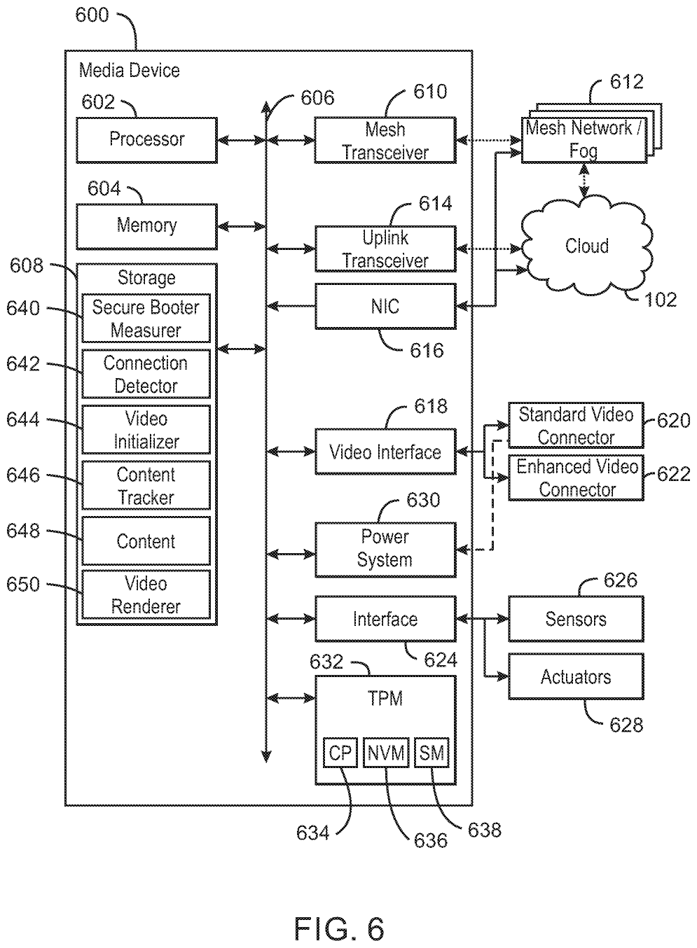

FIG. 6 is a block diagram of an example of components that may be present in a media device 600. The media device 600 may include any combinations of the components shown in the example. The components may be implemented as ICs, portions thereof, discrete electronic devices, or other modules, logic, hardware, software, firmware, or a combination thereof adapted in the media device 600, or as components otherwise incorporated within a chassis of a larger system. The block diagram of FIG. 6 is intended to show a high level view of components of the media device 600. However, some of the components shown may be omitted, additional components may be present, and different arrangement of the components shown may occur in other implementations.

The media device 600 may include a processor 602, which may be a microprocessor, a multi-core processor, a multithreaded processor, an ultra-low voltage processor, an embedded processor, or other known processing element. The processor 602 may be a part of a system on a chip (SoC) in which the processor 602 and other components are formed into a single integrated circuit, or a single package, such as the Edison™ or Galileo™ SoC boards from Intel. As an example, the processor 602 may include an Intel® Architecture Core™ based processor, such as a Quark™, an Atom™, an i3, an i5, an i7, a Xeon processor, or an MCU-class processor, or another such processor available from Intel® Corporation, Santa Clara, Calif. Other processing technologies may be used in tandem with, or in place of, the processors shown. These may include computing clusters, virtual processors and graphics processing units (GPUs), such as those available from nVidia® of Santa Clara, Calif., among others. However, any number other processors may be used, such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters. The processors may include units such as an A5-A9 processor from Apple® Inc., a Snapdragon™ processor from Qualcomm® Technologies, Inc., or an OMAP™ processor from Texas Instruments, Inc.

The processor 602 may communicate with a system memory 604 over a bus 606. Any number of memory devices may be used to provide for a given amount of system memory. As examples, the memory can be random access memory (RAM) in accordance with a Joint Electron Devices Engineering Council (JEDEC) low power double data rate (LPDDR)-based design such as the current LPDDR2 standard according to JEDEC JESD 209-2E (published April 2009), or a next generation LPDDR standard, such as LPDDR3 or LPDDR4 that will offer extensions to LPDDR2 to increase bandwidth. In various implementations the individual memory devices may be of any number of different package types such as single die package (SDP), dual die package (DDP) or quad die package (Q17P). These devices, in some embodiments, may be directly soldered onto a motherboard to provide a lower profile solution, while in other embodiments the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs. For example, a memory may be sized between 2GB and 16GB, and may be configured as a DDR3LM package or an LPDDR2 or LPDDR3 memory, which is soldered onto a motherboard via a ball grid array (BGA).

To provide for persistent storage of information such as data, applications, operating systems and so forth, a mass storage 608 may also couple to the processor 602 via the bus 606. To enable a thinner and lighter system design the mass storage 608 may be implemented via a solid state drive (SSD). Other devices that may be used for the mass storage 608 include flash memory cards, such as SD cards, microSD cards, xD picture cards, and the like, and USB flash drives. In low power implementations, the mass storage 608 may be on-die memory or registers associated with the processor 602. However, in some examples, the mass storage 608 may be implemented using a micro hard disk drive (HDD). Further, any number of new technologies may be used for the mass storage 608 in addition to, or instead of, the technologies described, such resistance change memories, phase change memories, holographic memories, or chemical memories, among others. For example, the media device 600 may incorporate the 3D XPOINT memories from Intel® and Micron®.

The components may communicate over the bus 606. The bus 606 may include any number of technologies, including industry standard architecture (ISA), extended ISA (EISA), peripheral component interconnect (PCI), peripheral component interconnect extended (PCIx), PCI express (PCIe), or any number of other technologies. The bus 606 may be a proprietary bus, for example, used in a SoC based system. Other bus systems may be included, such as an I²C interface, I³C interface, an SPI interface, point to point interfaces, and a power bus, among others.

The bus 606 may couple the processor 602 to a mesh transceiver 610, for communications with devices in a mesh network or fog 612. The mesh transceiver 610 may use any number of frequencies and protocols, such as 2.4 gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the devices in the mesh network or fog 612. For example, a WLAN unit may be used to implement Wi-Fi™ communications in accordance with the Institute of Electrical and Electronics Engineers (IEEE) 602.11 standard. In addition, wireless wide area communications, e.g., according to a cellular or other wireless wide area protocol, can occur via a WWAN unit.

The mesh transceiver 610 may communicate using multiple standards or radios for communications at different range. For example, the media device 600 may communicate with close devices, e.g., within about 10 meters, using a local transceiver based on BLE, or another low power radio, to save power. More distant devices in the mesh network or fog 612, e.g., within about 50 meters, may be reached over ZigBee or other intermediate power radios. Both communications techniques may take place over a single radio at different power levels, or may take place over separate transceivers, for example, a local transceiver using BLE and a separate mesh transceiver using ZigBee. The mesh transceiver 610 may be incorporated into an MCU as an address directly accessible by the chip, such as in the Curie® units available from Intel.

An uplink transceiver 614 may be included to communicate with devices in the cloud 302. The uplink transceiver 614 may be LPWA transceiver that follows the IEEE 802.15.4, IEEE 802.15.4g, IEEE 802.15.4e, IEEE 802.15.4k, or NB-IoT standards, among others. The media device 600 may communicate over a wide area using LoRaWAN™ (Long Range Wide Area Network) developed by Semtech and the LoRa Alliance. The techniques described herein are not limited to these technologies, but may be used with any number of other cloud transceivers that implement long range, low bandwidth communications, such as Sigfox, and other technologies. Further, other communications techniques, such as time-slotted channel hopping, described in the IEEE 802.15.4e specification may be used. It may be understood that a single radio transceiver my combine the functions of the mesh transceiver 610 and uplink transceiver 614.

Any number of other radio communications and protocols may be used in addition to the systems mentioned for the mesh transceiver 610 and uplink transceiver 614, as described herein. For example, the radio transceivers 610 and 614 may include an LTE or other cellular transceiver that uses spread spectrum (SPA/SAS) communications for implementing high-speed communications, such as for video transfers. Further, any number of other protocols may be used, such as Wi-Fi® networks for medium speed communications, such as still pictures, sensor readings, and provision of network communications.

The radio transceivers 610 and 614 may be part of a single transceiver unit included in the media device package. Further, the radio transceivers 610 and 614 may include radios that are compatible with any number of 3GPP (Third Generation Partnership Project) specifications, notably Long Term Evolution (LTE), Long Term Evolution-Advanced (LTE-A), Long Term Evolution-Advanced Pro (LTE-A Pro), or Narrow Band IoT (NB-IoT), among others. It can be noted that radios compatible with any number of other fixed, mobile, or satellite communication technologies and standards may be selected. These may include, for example, any Cellular Wide Area radio communication technology, which may include e.g. a 5th Generation (5G) communication systems, a Global System for Mobile Communications (GSM) radio communication technology, a General Packet Radio Service (GPRS) radio communication technology, or an Enhanced Data Rates for GSM Evolution (EDGE) radio communication technology. Other Third Generation Partnership Project (3GPP) radio communication technology that may be used includes UMTS (Universal Mobile Telecommunications System), FOMA (Freedom of Multimedia Access), 3GPP LTE (Long Term Evolution), 3GPP LTE Advanced (Long Term Evolution Advanced), 3GPP LTE Advanced Pro (Long Term Evolution Advanced Pro)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High-speed Packet Access), HSDPA (High-Speed Downlink Packet Access), HSUPA (High-Speed Uplink Packet Access), HSPA+ (High-speed Packet Access Plus), UMTS-TDD (Universal Mobile Telecommunications System—Time-Division Duplex), TD-CDMA (Time Division—Code Division Multiple Access), TD-SCDMA (Time Division—Synchronous Code Division Multiple Access), 3GPP Rel. 8 (Pre-4G) (3rd Generation Partnership Project Release 8 (Pre-4th Generation)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP LTE Extra, LTE Licensed-Assisted Access (LAA), UTRA (UMTS Terrestrial Radio Access), E-UTRA (Evolved UMTS Terrestrial Radio Access), LTE Advanced (4G) (Long Term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, Unlicensed Mobile Access (UMA, also referred to as also referred to as 3GPP Generic Access Network, or GAN standard)), Wireless Gigabit Alliance (WiGig) standard, mmWave standards in general (wireless systems operating at 10-90 GHz and above such as WiGig, IEEE 802.11ad, IEEE 802.11ay, and the like. In addition to the standards listed above, any number of satellite uplink technologies may be used for the uplink transceiver 614, including, for example, radios compliant with standards issued by the ITU (International Telecommunication Union), or the ETSI (European Telecommunications Standards Institute), among others. The examples provided herein are thus understood as being applicable to various other communication technologies, both existing and not yet formulated.

A network interface controller (NIC) 616 may be included to provide a wired or optical communication to the cloud 102 or to other devices, such as devices in the mesh network or fog 612. The NIC 616 may provide an Ethernet connection, or may be based on other types of networks, such as Controller Area Network (CAN), Local Interconnect Network (LIN), DeviceNet, ControlNet, Data Highway+, PROFIBUS, or PROFINET, among many others. An additional NIC 616 may be included to allow connect to a second network, for example, a NIC 616 providing communications to the cloud over Ethernet, and a second NIC 616 providing communications to other devices over another type of network.

The bus 606 may couple the processor 602 to a video interface 618 that is used to connect to a display panel. The video interface 618 may provide video feeds and extended interfaces to two different connectors a standard video connector 620 may be used to be compliant with the open pluggable specification (OPS). A second video connector 622 may provide enhanced video and extended interfaces, described herein as OPS+.

An interface 624 may be used to couple the media device to sensors 626. The sensors 626 may include cameras, motion sensors, position sensors, and sensors that may determine the location of a user or a line of sight of the user, such as an Intel® RealSense™ camera, among others. Other sensors 626 may include temperature sensors, pressure sensors, barometric pressure sensors, and the like. The interface 624 may be used to connect the media device 600 to actuators 628, such as power switches, an audible sound generator, a visual warning device, and the like.

The standard video connector 620 may include power line to power a power system 630 in the media device. The media device 600 may include a battery for backup purposes, for example, to maintain memory contents, communications, and the like. The use of a battery may accelerate restarting the system after power failure. The battery may be a lithium ion battery, a metal-air battery, such as a zinc-air battery, an aluminum-air battery, a lithium-air battery, a hybrid super-capacitor, and the like.

In some examples, a power block, or other power supply coupled to a grid, may be used to power the power system 630 and to charge a battery, if present. In some examples, the power system 630 may be replaced with a wireless power receiver to obtain the power wirelessly, for example, from the display panel through a loop antenna in the media device 600. The specific charging circuits chosen may depend on the current required. The power may be provided using the Airfuel standard promulgated by the Airfuel Alliance, the Qi wireless charging standard promulgated by the Wireless Power Consortium, or the Rezence charging standard, promulgated by the Alliance for Wireless Power, among others.

The media device 600 may include a trusted platform module (TPM) 632, for example, compliant with the specification promulgated by the Trusted Computing Group as ISO/IEC 11889 in 2009. The TMP 632 may include a cryptographic processor (CP) 634, non-volatile memory (NVM) 636, and secure memory (SM) 638. The CP 634 may provide a random number generator, an RSA hash generator, a SHA-1 hash generator, and an encryption-decryption engine, among others. The NVM 636 may include keys programed at the time of manufacture that include, for example, an RSA key, among others. The SM 638 may hold measurements taken on software in platform configuration registers. As used herein, a measurement is a hash code calculated on a code or data segment stored in the storage 608 or memory 604. Starting from a measurement of a boot code segment, the measurements may be used to establish a trusted execution environment (TEE), by creating a chain-of-trust from the initial booting.

The mass storage 608 may include a number of modules to implement the group creation functions described herein. Although shown as code blocks in the mass storage 608, it may be understood that any of the modules may be replaced with hardwired circuits, for example, built into an application specific integrated circuit (ASIC). The mass storage 608 may include a secure booter/measurer 640 that performs measurements on code or data. An initial boot measurement may be performed by the processor 802 to set up the secure booter/measurer 640 to perform additional measurements.

A connection detector 642 may be used to determine if only the standard video connector 620 is engaged, or if both the standard video connector 620 and the enhanced video connector 622 are engaged. A video initializer 644 may then set the parameters for providing the appropriate video through the connectors 620 and 622. For example, if the connection detector 642 determines that only the standard video connector 620 is coupled to a display panel, then the video initializer 644 configures the video interface 618 to provide a standard resolution video signal to the display panel through the standard video connector 620. If the connection detector 642 determines that both the standard video connector 620 and the enhanced video connector 622 are in communication with a display panel, then the video initializer 644 configures the video interface 618 to provide both a standard resolution video signal through the standard video connector 620, and a high resolution video signal through the enhanced video connector 622.

A content tracker 646 may be used to obtain content 648, such as advertisements, teaching information, shared video feeds for a video wall, and the like, from central servers or other media devices 600. The content tracker 646 may obtain content 648 on the basis of measurements provided by the sensors 626. For example, if the sensors determine a line of sight for a user is focused on an informational block on a display panel, the content tracker 646 may obtain further information for that informational block to expanded on the display panel. In other examples, the content tracker 646 may determine a gender, an identity, a viewing time, or other parameters about a user, and obtain appropriate content 648. The content tracker 646 may communicate with content trackers in other media devices in the fog 612, and pass content associated with that user to those media devices.

A video renderer 650 may take the content 648 and formatted to be provided over the video connectors 620 and 622 to a video panel. This may include, for example, transcoding a video stream to a different resolution for display. The video renderer 650 may also work with other media devices 600 to transfer portions of content that cross boundaries between display panels controlled by those other media devices 600.

Other units may be present to provide functionality as needed. For example, a blockchain, or other distributed ledger system, may be included to secure communications. A blockchain is transactional database that includes blocks of data that have transactions corresponding to content, content links, other media devices 600, and the like. In addition to identification information, the blockchain may include authorization information, such as public encryption keys for group objects and sub-objects. A copy of the blockchain may be kept on a portion or all of the media devices 600 in a mesh network. This allows other devices in the mesh network or fog 612 to confirm changes in the blockchain and flag any attempts to change the blockchain without proper authorization. Further, the blockchain may be used for any number of other transactions related to security, payments, transactions, and the like, for example, as a viewer interacts with the displayed advertisement.

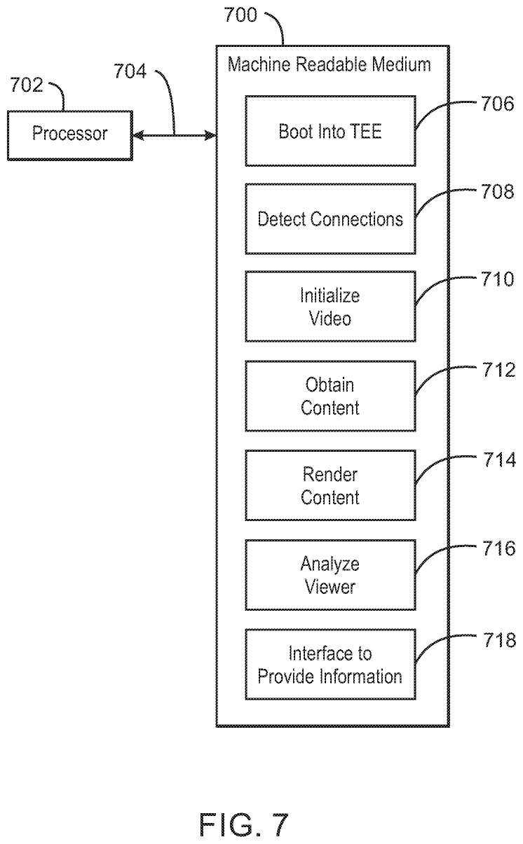

FIG. 7 is a block diagram of a non-transitory, machine readable medium 700 including code to direct a processor 702 to display enhanced video from a media device. The processor 702 may access the non-transitory, machine readable medium 700 over a bus 704. The processor 702 and bus 704 may be selected as described with respect to the processor 602 and bus 606 of FIG. 6. The non-transitory, machine readable medium 700 may include devices described for the mass storage 608 of FIG. 6 or may include optical disks, thumb drives, or any number of other hardware devices.

The non-transitory, machine readable medium 700 may include code 706 to direct the processor 702 to securely boot the media device into a trusted execute environment (TEE). Code 708 may be included to direct the processor 702 to detect what connections are active between the media device and a display panel. Code 710 may be included to direct the processor 702 to initialize video feeds to the display panel depending on what connections are active.

Code 712 may be included to direct the processor 702 to obtain content from a server or other media devices. The code 712 may also direct the processor to validate the identity of the media device, and the content provided to the media device. Code 714 may be included to direct the processor to render the content in an appropriate format for the display panel. Code 716 may be included to direct the processor 702 to use sensors to analyze a viewer, for example, determining the position of the viewer, the line of sight of the viewer, the motion of the viewer, the gender the viewer, and the like. Code 718 may be included to direct the processor 702 to provide an interface to the viewer for requesting specific information.

### EXAMPLES

Example 1 provides an apparatus including a media device. The media device includes a first video connector and a second video connector. The first video connector is to provide a video signal to a display panel at a first quality. The second video connector is to provide a second video signal to the display panel at a second quality. The media device includes a connection detector that determines the quality of the video signal to provide based, at least in part, on whether only the first video connector is coupled to the display panel or if both the first video connector and the second video connector are coupled to the display panel.

Example 2 includes the subject matter of example 1. In example 2, the quality includes a resolution, a frame rate, or both.

Example 3 includes the subject matter of either of examples 1 or 2. In example 3, the media device includes a video initializer to configure a video interface to provide the video signal through the first video connector, or through both the first and second connector.

Example 4 includes the subject matter of any of examples 1 to 3. In example 4, the media device includes a secure booter measurer to create a trusted execute environment (TEE).

Example 5 includes the subject matter of any of examples 1 to 4. In example 5, the media device includes a video renderer to render video at the first quality, the second quality, or both.

Example 6 includes the subject matter of any of examples 1 to 5. In example 6, the media device includes a content tracker to obtain and display content on the display panel.

Example 7 includes the subject matter of any examples 1 to 6. In example 7, a content tracker uses a sensor to obtain a parameter about a user.

Example 8 includes the subject matter of any examples 1 to 7. In example 8, a parameter includes a gender of the user, an identity of the user, a viewing time for content displayed, a line of sight for the user, or input from the user, or any combinations thereof.

Example 9 includes the subject matter of any examples 1 to 8. In example 9, a content tracker uses a parameter about the user to modify display of content on the display panel.

Example 10 includes the subject matter of any examples 1 to 9. In example 10, the content tracker uses a parameter about the user to obtain content for the display panel.

Example 11 includes the subject matter of any of examples 1 to 11. In example 11, the apparatus includes a display panel. The display panel includes a mate to the first video connector and a mate to the second video connector. The mate to the first video connector accepts a video signal at the first quality. The mate to the second video connector accepts a video signal at the second quality. Both the first video connector and the second video connector are coupled for connections supporting the second quality.

Example 12 includes the subject matter of any of examples 1 to 11. In example 12, the second video connector includes two HDMI 2.0 signals.

Example 13 includes the subject matter of any of examples 1 to 12. In example 13, the second video connector includes a PCIe x4 port.

Example 14 includes the subject matter of any of examples 1 to 13. In example 14, the second video connector includes a USB 3.0 port.

Example 15 provides a method for displaying enhanced video on a video panel using two connectors. The method includes plugging a media device into a display panel, and determining if two connectors on the media device are coupled to the display panel. If two connectors on the media device are coupled to the display panel, the media device is configured to provide enhanced video.

Example 16 includes the subject matter of example 15. In example 16, the method includes determining that only a first connector on the media device is coupled to the display panel, and providing standard video to the display panel through the first connector.

Example 17 includes the subject matter of either of examples 15 or 16. In example 17, the method includes providing at least two HDMI 2.0 signals to the display panel if the two connectors are coupled.

Example 18 includes the subject matter of any of examples 15 to 17. In example 18, the method includes providing a PCIe x4 link to the display panel if the two connectors are coupled.

Example 19 includes the subject matter of any of examples 15 to 18. In example 19, the method includes providing a general-purpose I/O (GPIO) to the display panel if the two connectors are coupled.

Example 20 includes the subject matter of any of examples 15 to 19. In example 20, the enhanced video includes a video signal with an 8K resolution at 60 Hz refresh.

Example 21 includes the subject matter of any of examples 16 to 20. In example 21, the standard video includes a video signal with a 4K resolution at 60 Hz refresh.

Example 22 provides a non-transitory, machine readable medium, including instructions that, when executed, direct a processor to detect whether a first connector and a second connector are electrically coupled to a display panel, and initialize a video system to provide an enhanced video signal to the display panel through the second connector.

Example 23 includes the subject matter of example 22. In example 23, the non-transitory, machine readable medium includes instructions that, when executed, direct the processor to provide at least two HDMI 2.0 video signals to the display panel through the second connector.

Example 24 includes the subject matter of either of examples 22 or 23. In example 24, the non-transitory, machine readable medium includes instructions that, when executed, direct the processor to provide a PCIe x4 link to the display panel through the second connector.

Example 25 includes the subject matter of any of examples 22 to 24. In example 25, the non-transitory, machine readable medium includes instructions that, when executed, direct the processor to provide a USB 3.0 link to the display panel through the second connector.

Example 26 includes the subject matter of any of examples 22 to 25. In example 26, the non-transitory, machine readable medium includes instructions that, when executed, direct the processor to detect that only the first connector is electrically coupled to the display panel, and initialize the video system to provide a standard video signal to the display panel through the first connector.

Example 27 includes the subject matter of any of examples 22 to 26. In example 27, the non-transitory, machine readable medium includes instructions that, when executed, direct the processor to obtain content for display, and render the content for display.

Example 28 includes the subject matter of any of examples 22 to 27. In example 28, the non-transitory, machine readable medium includes instructions that, when executed, direct the processor to determine a gender of a viewer, an identity for the viewer, a line of sight for the viewer, a viewing time for the viewer, or any combinations thereof.

Example 29 includes the subject matter of any of examples 22 to 28. In example 29, the non-transitory, machine readable medium includes instructions that, when executed, direct the processor to obtain content based on, at least in part the gender, the identity, the line of sight, or the viewing time or any combinations thereof.

Example 30 includes the subject matter of any of examples 22 to 29. In example 30, the non-transitory, machine readable medium includes instructions that, when executed, direct the processor to boot into a trusted execute environment.

Example 31 includes the subject matter of any of examples 22 to 30. In example 31, the non-transitory, machine readable medium includes instructions that, when executed, direct the processor to provide an interface to a viewer.

Example 32 provides an apparatus including a display panel. The display panel includes a first video connector and a second video connector. The first video connector is to receive a video signal from a media device at a first quality. The second video connector is to receive a second video signal from the media device at a second quality. The second quality is received only if both the first video connector and the second video connector are coupled to the display panel.

Example 33 includes the subject matter of example 32. In example 33, the quality includes 33 a resolution, a frame rate, or both.

Example 34 provides a non-transitory, machine-readable medium including instructions to direct a processor to perform any one of the methods of examples 15 to 21.

Example 35 provides an apparatus including means to perform any one of the methods of examples 15 to 21.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the techniques. The various appearances of “an embodiment”, “one embodiment”, or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

The techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the techniques.

1-25. (canceled)

26. An apparatus comprising a media device comprising:
a first video connector to provide a video signal to a display panel at a first quality; and
a second video connector to provide a second video signal to the display panel at a second quality, wherein the media device comprises a connection detector that determines a quality of the video signal to provide based, at least in part, on whether only the first video connector is coupled to the display panel or if both the first video connector and the second video connector are coupled to the display panel.

27. The apparatus of claim 26 wherein the quality comprises a resolution, a frame rate, or both.

28. The apparatus of claim 26, wherein the media device comprises a video initializer to configure a video interface to provide the video signal through the first video connector, or through both the first and second connector.

29. The apparatus of claim 26, wherein the media device comprises a secure booter measurer to create a trusted execute environment (TEE).

30. The apparatus of claim 26, wherein the media device comprises a video renderer to render video at the first quality, the second quality, or both.

31. The apparatus of claim 26, wherein the media device comprises a content tracker to obtain and display content on the display panel.

32. The apparatus of claim 31, wherein the content tracker uses a sensor to obtain parameters about a user.

33. The apparatus of claim 32, wherein the parameters comprise a gender of the user, an identity of the user, a viewing time for content displayed, a line of sight for the user, or input from the user, or any combinations thereof.

34. The apparatus of claim 32, wherein the content tracker uses the parameters about the user to modify display of content on the display panel.

35. The apparatus of claim 32, wherein the content tracker uses the parameters about the user to obtain content for the display panel.

36. The apparatus of claim 26, comprising the display panel, comprising:
a mate to the first video connector to accept a video signal at the first quality; and
a mate to the second video connector to accept a video signal at the second quality, and wherein both the first video connector and the second video connector are coupled for connections supporting the second quality.

37. The apparatus of claim 26, wherein the second video connector comprises two HDMI 2.0 signals.

38. The apparatus of claim 26, wherein the second video connector comprises a PCIe x4 port.

39. The apparatus of claim 26, wherein the second video connector comprises a USB 3.0 port.

40. A method for displaying enhanced video on a video panel using two connectors, comprising:
plugging a media device into a display panel;
determining if two connectors on the media device are coupled to the display panel; and
configuring the media device to provide enhanced video if the two connectors are coupled.

41. The method of claim 40, comprising providing at least two HDMI 2.0 signals to the display panel if the two connectors are coupled.

42. The method of claim 40, comprising providing a PCIe x4 link to the display panel if the two connectors are coupled.

43. The method of claim 40, comprising providing a general-purpose I/O (GPIO) to the display panel if the two connectors are coupled.

44. A non-transitory, machine readable medium, comprising instructions that, when executed, direct a processor to:
detect whether a first connector and a second connector are electrically coupled to a display panel; and
initialize a video system to provide an enhanced video signal to the display panel through the second connector.

45. The non-transitory, machine readable medium of claim 44, comprising instructions that, when executed, direct the processor to provide at least two HDMI 2.0 video signals to the display panel through the second connector.

46. The non-transitory, machine readable medium of claim 44, comprising instructions that, when executed, direct the processor to provide a PCIe x4 link to the display panel through the second connector.

47. The non-transitory, machine readable medium of claim 44, comprising instructions that, when executed, direct the processor to provide a USB 3.0 link to the display panel through the second connector.

48. The non-transitory, machine readable medium of claim 44, comprising instructions that, when executed, direct the processor to:
detect that only the first connector is electrically coupled to the display panel; and
initialize the video system to provide a standard video signal to the display panel through the first connector.

49. The non-transitory, machine readable medium of claim 44, comprising instructions that, when executed, direct the processor to:
obtain content for display; and
render the content for display.

50. The non-transitory, machine readable medium of claim 44, comprising instructions that, when executed, direct the processor to obtain content based on, at least in part a gender, the identity, a line of sight, or a viewing time, or any combinations thereof.
